(19) United States
(12) Patent Application Publication
(10) Pub. No.: US 2006/0088500 A1
(43) Pub. Date: Apr. 27, 2006

(54) Animal lure candle

(76) Inventor: Jeffrey Cole, Rockwell, NC (US)

Correspondence Address: Donald W. Meeker;Patent Agent, 924 East Ocean Front #E, Newport Beach, CA, 92661, US

(21) Appl. No.: 10/974,087

(22) Filed: Oct. 26, 2004

(51) Int. Cl. A01N 25/00

(52) U.S. Cl. 424/84

(57) ABSTRACT

A candle is formed from a heated mixture of liquid wax, an animal attracting scent, and a scent retention additive. A wire core wick imbedded in the candle mixture is lighted to give off the animal attracting scent into the air. A container shields the candle from the wind, but lets the scent out a top opening. The candle may be formed in an aluminum container and the container used as the candle holder and wind guard while burning the candle. A chimney may be constructed from a fiberboard bend to form panels with bottom flaps forming a tie down base to put over the candle while burning.

### BACKGROUND OF THE INVENTION

1. Field of the Invention

The present invention relates to an animal scent lure and particularly to a candle that contains deer estrus scent, which is released into the air by lighting the candle, thereby a attracting a species of animal in the deer family, including whitetail or blacktail deer, mule deer, elk, caribou and moose.

2. Description of the Prior Art

The use of scents to attract animals is well known. Deer scents such as doe urine are used to attract deer particularly bucks, such scents are dispensed in a number of ways. A hunter will use it on his or her clothing to mask the natural odors. Other times it is distributed at a site to attract game to that location. Deer scent dispensing or diffusion systems are well known, such as devices that drip deer scent on the ground, employ a heater to aid in diffusing the scent or use a wick or other absorbent material.

U.S. Pat. No. 5,555,665, issued Sep. 17, 1996 to Fore, shows a scent-releasing pole for attracting deer to a hunter. Two tapers are disposed in a hollow tube, and extend above the open upper end of the tube. Each taper is made up of a combustible stick, around the upper end of which is wrapped a layer of peat. The layer of peat is partly overlaid with a semicircular layer of wax impregnated with a scent which attracts deer. The scent is released by burning the tapers.

U.S. Pat. No. 5,914,119, issued Jun. 22, 1999 to Dawson, indicates a process and product for attracting animals and covering human scent. An animal lure and cover scent process and product is provided, which employs a combustible absorbent material impregnated with an aromatic substance having fragrance attractive to an animal, with the absorbent material being of restricted combustibility such that the absorbent material tends to smoke without producing a flame as it burns, the smoke entraining the fragrance with it as it travels through the air. The combustible absorbent material of the present invention is in the form of an incense stick wherein a cellulosic material formed from sawdust is coated on one end of a combustible bamboo stick. A weather shield protects the incense stick from wind and rain.

U.S. Pat. No. 5,618,548, issued Apr. 8, 1997 to Dawson, indicates a process and product for attracting animals and covering human scent. An animal lure and cover scent process and product employs a combustible absorbent material impregnated with an aromatic substance having fragrance attractive to an animal, with the absorbent material being of restricted combustibility such that the absorbent material tends to smoke without producing a flame as it burns, the smoke entraining the fragrance with it as it travels through the air. The combustible absorbent material of the present invention is in the form of an incense stick wherein a cellulosic material formed from sawdust is coated on one end of a combustible bamboo stick. A weather shield protects the incense stick from wind and rain.

U.S. Patent Application #20030037476, published Feb. 27, 2003 by Peavy, is for a method and dispenser for attracting wild animals utilizing readily, commercially available hand warmer pads and commercially available wild animal scent sources, both of which are familiar to most wild game hunters. These products are used in a pouch formed of a material through which the scent may penetrate to provide the final dispenser.

U.S. Pat. No. 6,038,805, issued Mar. 21, 2000 to Smidtke, is for a scent steamer with collapsible upper and lower sections. The upper section holds bottles of liquid scent which are heated from the lower section, thereby causing the scents to vaporize in a slow manner into the surrounding environment.

U.S. Pat. No. 5,094,025, issued Mar. 10, 1992 to Daniels, provides an animal scent heater, which electrically heats animal scent using a resistive heating element and a wick to draw scent from a container.

U.S. Pat. No. 5,916,552, issued Jun. 29, 1999 to Perry, claims a semi-solid deer attractant lure comprised of liquid deer urine plus a sufficient amount of flavorless gelatin to produce a semi-solid rubbery composition. Also disclosed, is a method of making and a method of using the deer attractant lure composition.

U.S. Pat. No. 5,359,801, issued Nov. 1, 1994 to Mattucci, describes a scent dispenser that includes an upper reservoir which holds a liquid scent source and a lower chamber which houses an adjustable burner. The burner emits heat to the upper reservoir and exhausts through a central vent pipe, causing the scent held in the upper chamber to volatilize. Exhaust from the vent pipe entrains volatilized scent and carries it into the atmosphere. A method for dispensing scent is also disclosed.

U.S. Pat. No. 5,429,271, issued Jul. 4, 1995 to Porter, discloses a game scent dispenser that includes a scent warmer to keep the scent aromatic in cold temperature environs.

U.S. Pat. No. 5,555,663, issued Sep. 17, 1996 to Burgeson, puts forth a heated animal scent lure dispenser, which includes a container with an interior, exterior, threaded neck and opening at the neck. A cap is threadable onto the neck for at least partially closing the opening. A heating element or chemical charge is locatable within the container which will in turn heat the container. A wick suitably made from a knit fabric substantially covers the container with a large surface area upon which the liquid scent lure may be placed and from which the liquid scent lure may be dispersed under the influence of the heated container. The wick may also have insulation qualities and a suitable plastic bag or the like may be used to seal the dispenser within the bag and to starve the dispenser from oxygen.

U.S. Pat. No. 5,161,646, issued Nov. 10, 1992 to Aurich, concerns a device for dispensing animal attractant scents that has a case in which are housed a power source and a bottle containing a supply of liquid animal attractant scent. A wick having a heat generating resistor is mounted in the wick and coupled to the power source to heat the animal attractant scent drawn near it by capillary action from the bottle causing it to vaporize rapidly and be dispensed into ambient air.

U.S. Pat. No. 4,771,563, issued Sep. 20, 1988 to Easley, illustrates a lightweight, portable device that maintains at a warm temperature a quantity of animal scent, particularly animal urine, which is used by hunters to attract animals. A battery operated heating element surrounding a chamber which removably receives a vial of the liquid scent maintains the temperature of the liquid above freezing when the device is used outdoors in cold weather, and preferably heats the scent to a temperature which closely imitates the fresh presence of live deer. The device includes a cap having two oppositely oriented threaded sections, one of the which when received on a housing of the device closes the chamber containing the liquid while the other when received on the housing enables vent openings formed in the cap to dissipate odors which emanate from the vial. Batteries of the device are located within an enlarged base and thus provide a low center of gravity, which allows the device to remain in a stable, upright orientation on the ground when desired.

U.S. Pat. No. 6,240,248, issued May 29, 2001 to Fore, is for a game attractant heating device for heating a quantity of liquid game attractant to a temperature between 90 and 130.degrees Fahrenheit. The heating device preferably includes multiple liquid attractant holding chambers each with a separate heating element for simultaneously heating two liquid attractants simultaneously. The heating device is also preferably battery powered.

U.S. Pat. No. 5,744,106, issued Apr. 28, 1998 to Eagle, provides a heated scent dispenser. The device has a reservoir which is heated by igniting paraffin or an equivalent fuel. A wick draws fuel from a fuel tank containing the paraffin, the wick being enclosed in a first chamber to avoid exposure to the elements. A second chamber disposed above the first chamber contains a fluid reservoir which can be filled with animal urine or other scent. A dome top is disposed above the housing to distribute the scent horizontally in all directions. The entire assembly is contained within a shroud to provide additional protection from exposure to wind, rain, snow, etc. so as to be operable in virtually any environment. The device may also be used to distribute insect repellent or other similar aromatic by removing the heating tank and filling the fuel tank with the aromatic. Once ignited, the fumes are distributed out of open scent reservoir.

U.S. Pat. No. 4,937,431, issued Jun. 26, 1990 to Jameson, shows an apparatus for producing heat to enhance an animal lure scent containing a hollow body, a base removably disposed to one end of the hollow body, and a body cap rotatably secured to another end of the hollow body. An electronic circuitry is disposed in the hollow body and includes a heat pot for supplying an odorless heat having a temperature of the body temperature of an animal to be lured. A scent pad is positioned against and over the heat pot to hold a scent of the animal to be lured and to insulate the heat pot during operation. U.S. Pat. No. 4,852,288, issued Aug. 1, 1989 to Payne, claims an articulated game decoy activated by wind, which is formed of sheet material and has a main body member adapted to be mounted on trees or shrubs, a head and neck member pivotally connected to the main body, elastic members connected between the head and neck member and main body member, and ears attached transverse to the head portion of the head and neck member to catch the wind and oscillate the head and neck member relative to the main body when subjected to a breeze. The main body may have an integral tail portion, or have a separate tail member pivotally connected thereto with elastic members therebetween which will also oscillate when subjected to a breeze. The sheet material may have a weather resistive wax coating and the main body may be provided with a scent impregnated wax coating, or with a recess or aperture to receive a scented insert to attract wild game.

U.S. Pat. No. 3,046,192, issued Jul. 24, 1962 to Bilyeu, describes a composition of wild animal scent and a catalytic-type warmer/receptacle for heating the wild animal scent to cause it to be diffused and carried off into the air with the products of combustion from the catalytic-type warmer, thereby luring wild game.

U.S. Pat. No. 3,119,650, issued Jan. 28, 1964 to Bilyeu, discloses a catalytic-type warmer/receptacle for heating wild animal scent to cause it to be diffused and carried off into the air with the products of combustion from the catalytic-type warmer, thereby luring wild game.

None of the prior art devices provide an animal lure scent in a candle. What is needed is an animal lure scent which is impregnated in a candle which can be lighted in a wind sheltered container to send off the animal lure scent from the candle into the surrounding area while hunting.

### SUMMARY OF THE INVENTION

An object of the present invention is to provide a wax candle impregnated with an animal lure scent which candle can be lighted in a wind sheltered container to send off the animal lure scent from the candle into the surrounding area while hunting.

Another object of the present invention is to include a scent retention additive to the wax and animal lure scent to retain the scent in the candle until use.

One more object of the present invention is to form the candle by melting measured amounts of paraffin wax, animal attracting scent, and scent retention additive together and pouring them around a wick and letting the mixture harden to form the candle.

An additional object of the present invention is to pour the heated wax, lure scent, and scent retention mixture into an aluminum container around a wick and let the mixture harden to form the candle within the container which may be used to shelter the candle from the wind.

A further object of the present invention is to provide a chimney for sheltering the candle by bending a flat sheet into enclosing panels and connecting them together, which sheet folds up flat for storage and transporting.

A contributory object of the present invention is to bend flaps at the bottom of the panels either in to be held down by the candle or out to be staked to the ground to hold down the chimney.

An added object of the present invention is to provide an opening at the top of a sheltering container or chimney to allow the animal lure scent to disperse into the air from the burning candle.

In brief, an animal lure candle device for luring animals while hunting comprises a candle formed by mixing and heating a wax base, preferably a paraffin wax, intermixed with an animal attractive scent and a scent retention additive, preferably vybar, to retain the animal attractive scent in the candle until the candle is lighted, and an imbedded wick, preferably a wire core wick, for burning to release the animal attractive scent into the air to attract an animal.

The animal attractive scent is a scent taken from the list of scents including natural animal attractive scents of estrous urine from a white tail doe deer, urine scents of dominant buck urine and young buck urine and various buck and doe deer pheromones, buck tarsal gland secretions, natural food scents including corn, acorn, honeysuckle, and berry and synthetic animal attractive scents.

A container or chimney shelters the candle from wind during burning and allow animal lure scent to disperse into the air from the lighted candle through a top air release opening.

An advantage of the present invention is that it provides a convenient way for a hunter to carry and disperse an animal lure scent.

Another advantage of the present invention is that it enables the use of a variety of types of animal lure scents which are retained within the candle mixture until the candle is burned.

An additional advantage of the present invention is that a folding construction of a chimney folds flat for storing and transporting.

One more advantage of the present invention is that an aluminum container used to form the candle can be used to shelter the wind.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a cross-sectional view of a container being used to form the animal lure candle of the present invention around a wick by pouring in a heated mixture of the wax, animal lure scent, and scent retention additive;

FIG. 2 is a cross-sectional view of the container of FIG. 1 with the mixture hardened around the wick to form the animal lure candle which can be used in the container;

FIG. 3 is a side elevational view of a chimney for sheltering the animal lure candle inside the chimney;

FIG. 4 is a top plan view of the chimney of FIG. 3 showing the top of the animal lure candle through a top opening in the chimney;

FIG. 5 is a flat plan view of the sheet with fold lines and slits used to be bent into the chimney of FIG. 3;

FIG. 6 is a side elevational view of the chimney of FIG. 3 with the candle burning inside the chimney releasing the animal lure scent into the air.

### BEST MODE FOR CARRYING OUT THE INVENTION

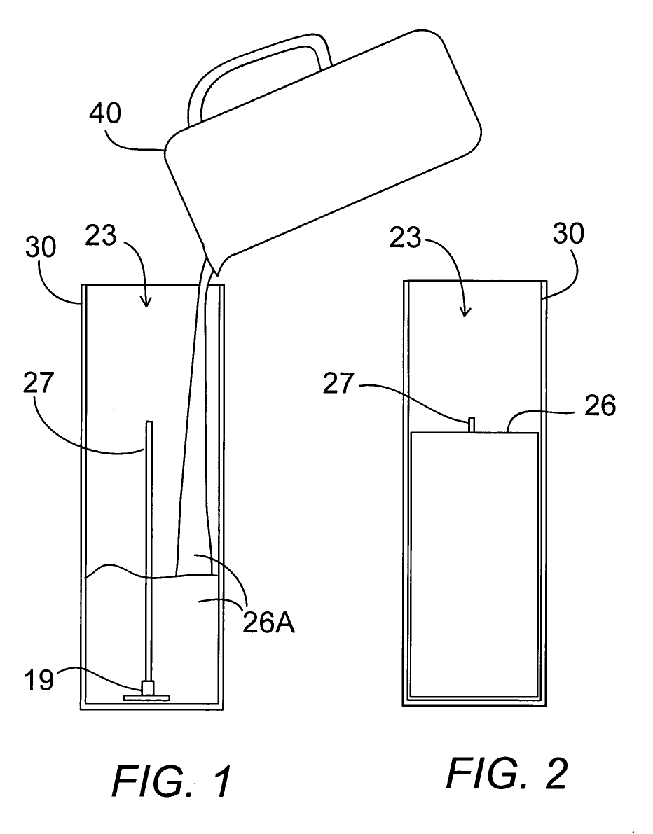

In FIGS. 1-6, an animal lure candle device 20 for luring animals while hunting comprises a candle 26 comprising a wax base, preferably a paraffin wax, intermixed with an animal attractive scent and a scent retention additive, preferably vybar, to retain the animal attractive scent in the candle until the candle is lighted, and an imbedded wick 27, preferably a wire core wick, for burning to release the animal attractive scent into the air to attract an animal.

The animal attractive scent is a scent taken from the list of scents including natural animal attractive scents of estrous urine from a white tail doe deer, urine scents of dominant buck urine and young buck urine and various buck and doe deer pheromones, buck tarsal gland secretions, natural food scents including corn, acorn, honeysuckle, and berry and synthetic animal attractive scents.

A container 30 or chimney 30A for the candle 26 shelters the candle from wind during burning. The container 30 or chimney 30A has at least one top air release opening 23 to release the animal scent 29 from the burning candle into surrounding air, as shown in FIG. 6.

In FIGS. 1 and 2, the container 30 comprises an aluminum container into which a heated liquid mixture 26A of the wax, the animal attractive scent and a scent retention additive and the wick 27 are placed to harden into a candle 26 for use with the container 30.

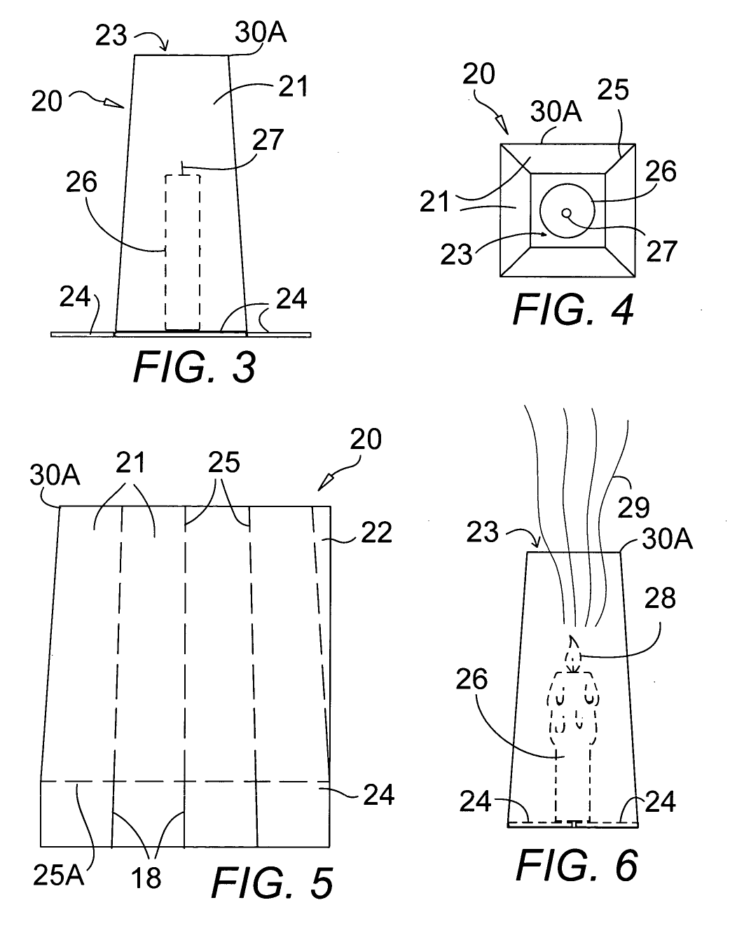

In FIGS. 3-6 a chimney 30A may be constructed to cover the candle 26 and help the candle to burn more effectively and keep the wind from blowing the candle out. The chimney 30A preferably comprises a folded candle encircling construction fabricated from a sheet of flat bendable material 30A, shown in FIG. 5, with flaps 24 at a bottom of the chimney that can be bent out and staked down outside of the chimney, is in FIG. 3, or folded under the candle 26, as in FIG. 6, to hold down the chimney 30A. The chimney 30A is preferably fabricated from a sheet of posterboard-like material formed with creased fold lines 25 bent to form side panels 21 and a series of bottom flaps 24 separated by slits 18 between flaps 24, the bottom flaps folding out or in along fold lines 25A between the flaps and the panels. A small edge panel 22 folds over and adheres to the panel 21 at the opposite edge of the sheet to enclose the chimney 30A to encircle and shelter the candle 26.

In use, the container 30 with the formed candle is set down in a strategic location at a hunting site, or a number of them set down or the chimney 30A is set up around the candle 26, or a number of them set up around the site. The wick 27 of the candle 26 is lighted to release the animal attractive scent 29 through the top opening 23 into the air at a hunting site to attract animals, as shown in FIG. 6.

It is understood that the preceding description is given merely by way of illustration and not in limitation of the invention and that various modifications may be made thereto without departing from the spirit of the invention as claimed.

What is claimed is:

1. An animal lure candle device for luring animals while hunting, the device comprising:
a candle comprising a wax base intermixed with an animal attractive scent and a scent retention additive to retain the animal attractive scent in the candle until the candle is lighted, the and an imbedded wick for burning to release the animal attractive scent into the air to attract an animal.

2. The device of claim 1 wherein the animal attractive scent is a scent taken from the list of scents including natural animal attractive scents of estrous urine from a white tail doe deer, urine scents of dominant buck urine and young buck urine and various buck and doe deer pheromones, buck tarsal gland secretions, natural food scents including corn, acorn, honeysuckle, and berry and synthetic animal attractive scents.

3. The device of claim 1 wherein the wax base is a paraffin wax.

4. The device of claim 1 wherein the scent retention additive is vybar.

5. The device of claim 1 wherein the wick is a wire core wick.

6. The device of claim 1 further comprising a container for the candle to shelter the candle from wind during burning, the container having at least one top air release opening to release the animal scent from the burning candle into surrounding air.

7. The device of claim 6 wherein the container comprises an aluminum container into which a heated liquid mixture of the wax, the animal attractive scent and a scent retention additive and the wick are placed to harden into a candle for use with the container.

8. The device of claim 1 further comprising a chimney adapted to cover the candle and help the candle to burn more effectively and keep the wind from blowing the candle out.

9. The device of claim 8 wherein the chimney comprises a candle encircling folded construction fabricated from a sheet of flat bendable material with panels formed by bending the sheet at each of a series of vertical crease lines, the panels being bent around and closed by an edge tab adhered to an opposite edge panel to form a closed encircling chimney around the candle and flaps formed between a series of slots at a bottom of the sheet with crease lines between the flaps and the panels so that the flaps can be bent out and staked down or bent in folded under the candle to hold down the chimney by the weight of the candle.

10. The device of claim 9 wherein the chimney is fabricated from a sheet of posterboard-like material formed with creased fold lines.
